(19) United States
(12) Patent Application Publication
(10) Pub. No.: US 2003/0076302 A1
(43) Pub. Date: Apr. 24, 2003

(54) Joystick input device for palmtop information appliance

(75) Inventor: James R. Langstraat, Elk Point, SC (US)

Correspondence Address: GATEWAY, INC., ATTN: SCOTT CHARLES RICHARDSON, 610 GATEWAY DRIVE, MAIL DROP Y-04, N. SIOUX CITY, SD, 57049, US

(73) Assignee: Gateway, Inc.

(21) Appl. No.: 10/004,437

(22) Filed: Oct. 24, 2001

(51) Int. Cl. G09G 5/08

(52) U.S. Cl. 345/161; 345/179

(57) ABSTRACT

A joystick assembly for a palmtop information appliance comprises a socket disposed in the housing of the appliance for receiving an end of the stylus used for inputting information into the appliance via a digitizer, touch screen, or the like. The socket includes a detector for detecting movement of the stylus received in the socket and controlling indicia displayed by the appliance in response thereto. In this manner, the stylus can be used as a joystick for controlling functions of the palmtop information appliance.

### FIELD OF THE INVENTION

The present invention generally relates to the field of palmtop information appliances, and more particularly to a palmtop information appliance having a joystick input device.

### BACKGROUND OF THE INVENTION

Palmtop information appliances, commonly known in the art as palmtop computers, personal digital assistants (PDAs), or the like, are comprised of a class of portable computers whose size enable them to be held in one hand while being operated with the other. Typically, palmtop information appliances include a display having a digitizer or touch sensitive panel allowing a user to enter information and commands using a stylus, pen or the like. One or more control buttons may also be provided for entering common commands, selecting menus to be displayed, adjusting display qualities, and the like. In some embodiments, control buttons arranged in a “+” configuration may be provided for navigation within the user interface employed by the appliance.

Such palmtop information appliances are becoming increasingly capable of supporting sophisticated software applications such as address book and calendar software, Internet browsers, email, and the like. To implement such software applications, it may be desirable to employ a graphical user interface using a cursor for selection of command, choosing data to be manipulated, or the like. Moreover, palmtop information appliances are commonly provided with popular gaming applications for the entertainment of their users. Such gaming applications often employ characters that must be precisely manipulated while playing the game.

Controls provided by existing palmtop information appliances (i.e., the control buttons and the stylus/digitizer) do not readily facilitate accurate manipulation of a cursor or gaming character since such controls do not allow true 360 degree movement of such indicia. Moreover, conventional cursor control devices such as mouses, trackballs, a conventional joystick, or the like are not well suited for use by palmtop information appliances due to the small size of the appliances. Consequently, more sophisticated user interfaces or gaming applications may be difficult to use, lessening the utility of the palmtop information appliance.

### SUMMARY OF THE INVENTION

Accordingly, the present invention is directed to a joystick assembly for a palmtop information appliance that readily facilitates accurate manipulation of indicia such as a cursor, gaming character or the like. In an exemplary embodiment, a socket is disposed in the housing of the palmtop information appliance for receiving an end of the stylus used for inputting information via a digitizer, touch screen, or the like. The socket includes a detector for detecting movement of the stylus received in the socket so that the stylus can be used as a joystick for controlling functions of the palmtop information appliance. The palmtop information appliance may further comprise one or more control buttons that are suitable for use in conjunction with the stylus for controlling the functions of the palmtop information appliance.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF TIHE DRAWINGS

The numerous advantages of the present invention may be better understood by those skilled in the art by reference to the accompanying figures in which:

FIG. 1 is an isometric view illustrating a palmtop appliance in accordance with an exemplary embodiment of the present invention;

FIG. 2 is an isometric view illustrating the palmtop information appliance shown in FIG. 1, further illustrating removal of a stylus from a holder disposed in the housing of the appliance;

FIG. 3 is an isometric view illustrating the palmtop information appliance shown in FIG. 2, further illustrating use of the stylus for inputting information, commands, and the like via a digitizer disposed of the display of the appliance;

FIG. 4 is an isometric view illustrating the palmtop information appliance shown in FIG. 2, further illustrating use of the stylus as a joystick for inputting information, commands and the like for controlling functions of the appliance; and

FIG. 5 is a cross-sectional end elevation view of the palmtop information appliance shown in FIG. 4, further illustrating the socket provided for receiving the stylus so that the stylus may be used as a joystick.

### DETAILED DESCRIPTION OF THE INVENTION

Reference will now be made in detail to the presently preferred embodiments of the invention, examples of which are illustrated in the accompanying drawings.

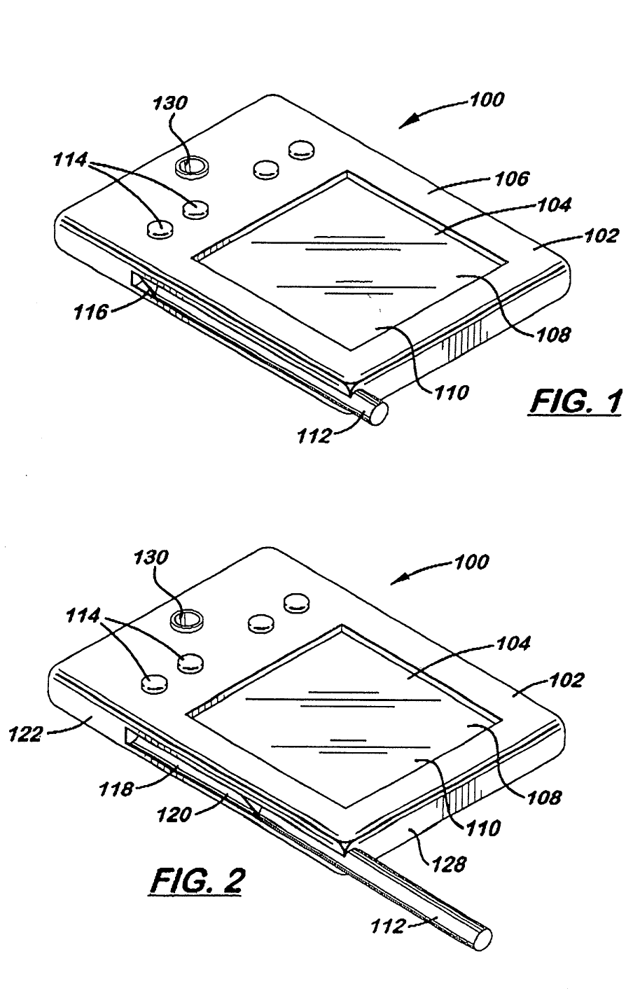

FIGS. 1 through 5 illustrate a palmtop information appliance 100 in accordance with an exemplary embodiment of the present invention. The palmtop information appliance 100 includes a housing 102 sized and shaped to be held comfortably in the hand of a user. A display/digitizer assembly 104 is disposed in an upper surface 106 of housing 102 so that it may be accessed when the appliance 100 is held in the hand of a user. In exemplary embodiments, the display/digitizer assembly 104 includes a display 108 such as a liquid crystal display, a plasma display, or the like. Further, display 108 may be either a monochrome display or a color display. A substantially transparent touch sensitive panel or digitizer 110 is disposed over display 108 for allowing a user to enter information and commands using a stylus, pen or the like 112. One or more control buttons 114 may be provided on upper surface 106 adjacent to display/digitizer assembly 104. The control buttons 114 may be used for a variety of purposes depending on the operating system and software applications running on the palmtop information appliance 100. For example, in one embodiment, control buttons 114 may be used for entering common commands, selecting menus to be displayed, adjusting display qualities, providing navigation within the user interface employed by the appliance 100, or the like.

Stylus 112 is comprised of a cylindrical member having a first end 116 suitable for contacting the surface of digitizer 110 for entry of commands and information. It will be appreciated that the precise shape of stylus 112 may vary depending on specific design requirements of the palmtop information appliance 100 without departing from the scope and spirit of the invention. For instance, in exemplary embodiments, first end 116 of stylus 112 may include a generally pointed tip for allowing the user to more accurately select small regions of the digitizer 110. In such embodiments, first end 116 may have any of several tapers or shapes (e.g., conical, ogival, paraboloidal, or the like). In other embodiments, first end 116 of stylus 112 may include a rounded or blunt tip having little or no taper. In still further embodiments, stylus 112 may include multiple tips (e.g., a pointed stylus tip and a blunt stylus tip, a stylus tip in combination with pen, pencil and/or laser pointer tips, or the like) each capable of being selectively extended and retracted much like the writing tip of a conventional ball point pen.

When not in use, the stylus 112 may be stored in a holder 118 formed in or attached to housing 102. In exemplary embodiments, holder 118 is comprised of a generally cylindrical channel 120 formed in a surface (e.g., side face 122) of housing 102. In the embodiment shown, generally cylindrical channel 120 includes a bottom surface 124 and forms an aperture 126 in a top surface 128 of housing 102. When stored in holder 118, stylus 112 is inserted into this channel 120 through aperture 126 until its first end 116 is generally adjacent to bottom surface 124. In one embodiment, cylindrical channel 120 may contact the shaft of stylus 112 above first end 116 for retaining the stylus within the holder 118. In other embodiments, channel 120 may include a concavity adjacent to bottom surface 124. This concavity may have a shape generally corresponding to the shape of the first end 116 of stylus 112 for receiving first end 116 to retain stylus 112 within channel 120

As shown in FIGS. 2 and 3, stylus 112 may be removed from holder 118 and used for entering information, commands, and the like via digitizer 110 of display/digitizer assembly 104 by selecting areas of the digitizer 110 corresponding to icons, indicia, or the like, displayed by display 108. In exemplary embodiments, the user of the palmtop information appliance 100 may further utilize stylus 112 for entering information by “writing” characters onto the digitizer 110. These characters may then be interpreted by a suitable handwriting recognition software application. Such applications are well known in the art of palmtop appliances.

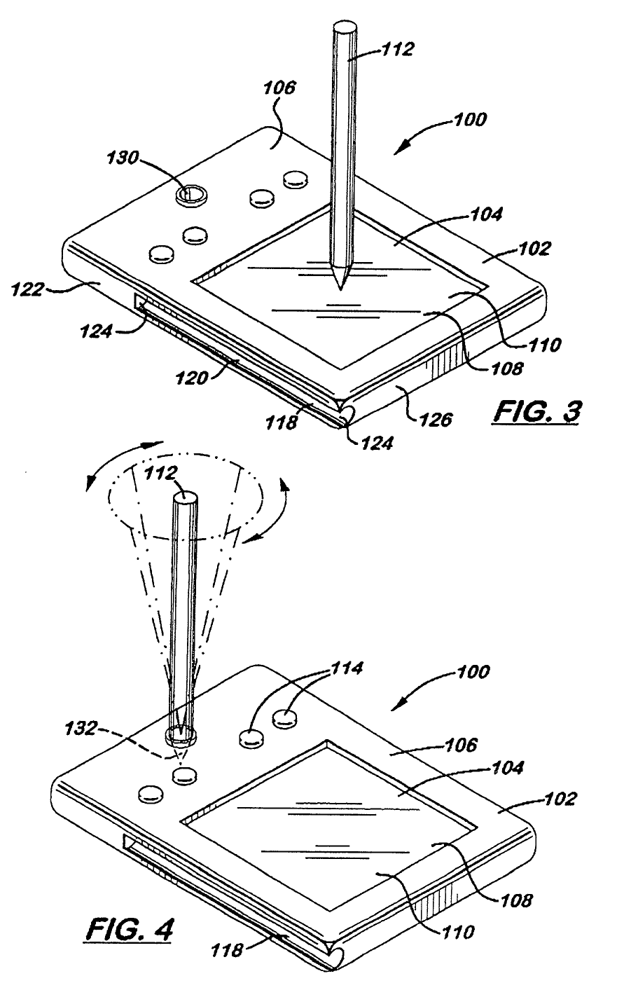

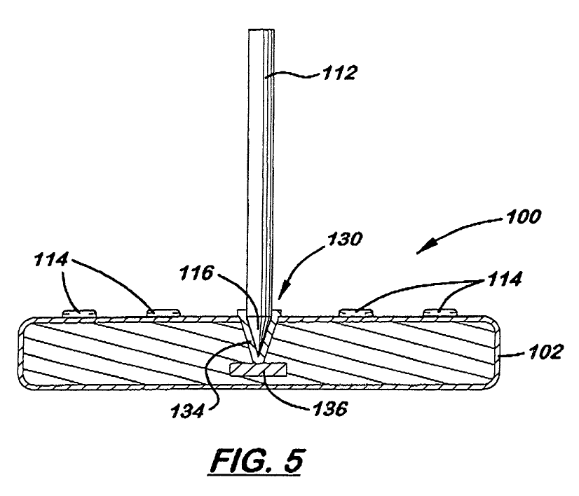

In exemplary embodiments of the invention, a socket 130 is disposed in the upper surface 106 of housing 102 for receiving the first end 116 of stylus 112. In this manner, stylus 112 may be utilized as the vertical stem of a simple joystick assembly 132 to facilitate accurate manipulation of indicia such as a cursor, gaming character, or the like displayed by display 108 for controlling functions of the palmtop information appliance 100. As shown in FIG. 4, socket 130 may include a generally cone shaped cavity sized for receiving the generally pointed first end 116 of stylus 112. In exemplary embodiments, socket 130 allows 360-degree movement of stylus 112 (e.g., horizontal or side-to-side movement, vertical or up-and-down movement, circular movement, diagonal movement, and the like). In this manner, more precise movement of indicia (e.g., cursors, gaming characters and the like) displayed by display 108 may be achieved.

In the embodiment shown in FIGS. 1 through 4, socket 130 is positioned below display/digitizer assembly 104 adjacent to control buttons 114 as viewed by a user of the palmtop information appliance 100 when the appliance 100 is being used. As shown in FIG. 4, socket 130 may further be centered horizontally in upper surface 106 so that the stylus may be manipulated by the right or left hand of the user. However, it will be appreciated that the position of socket 130 in housing 102 may be varied by those of skill in the art depending on specific design requirements of the palmtop information appliance 100 without departing from the scope and spirit of the present invention.

In exemplary embodiments of the invention, one or more of control buttons 114 may be used in conjunction with stylus 112 (when used as a joystick) for controlling functions of the palmtop information appliance 100. For instance, when inserted in socket 130 to provide joystick assembly 132, stylus 112 may be manipulated to move a cursor over an icon displayed by display 108. A control button 114 may then be depressed to select or “click” on that icon to provide a fiction, initiate a software application, or the like. Similarly, in gaming applications, joystick assembly 132 may be used for controlling the movement of a character within the game, while control buttons are used to provide functions of the game (e.g., fire, shields, jump, duck, run faster, etc.).

Moreover, joystick assembly 132 may be used in conjunction with digitizer 110. Stylus 112 may be periodically removed from socket 130 to be used for inputting information and commands via digitizer 110. In exemplary embodiments, the indicia (e.g., a cursor) controlled by the joystick assembly formed by stylus 112 and socket 130 may remain in a fixed position on display 108 when stylus 112 is removed from socket 130. In this manner, the stylus 112 may be readily used to select commands, or input information via the digitizer 110, and then reinserted into the socket 130 for use as a joystick stem.

Referring now to FIG. 5, socket 130 is described. Socket 130 includes a boot 132 sized and shaped for receiving an end of the stylus 112. In the embodiment shown, boot 134 is provided with a generally conical cavity for receiving the pointed first end 116 of stylus 112. Boot 134 may further provide an environmental seal with housing 102 to prevent the intrusion of environmental contaminants (e.g., moisture, dust, electromagnetic interference (EMI) and the like) into housing 102. In exemplary embodiments, boot 134 may be formed of a resilient material such as rubber, vinyl, plastic, or the like allowing movement of stylus 112 received in socket 130 as a joystick stem.

As shown in FIG. 5, boot 134 is coupled to a detector 136 for detecting movement of the stylus 112. In exemplary embodiments, detector 136 comprises a force sensing apparatus for sensing lateral motion imparted to the stylus 112 when the stylus 112 is received in the socket 130. In this manner, the detector 136 measures movement of the stylus 112 by measuring the resultant movement of the boot 134 itself. Force sensing apparatus employed by detector 136 may employ a variety of sensing technologies. For instance, the force sensing apparatus may comprise strain gauges or pressure sensitive resistive material capable of sensing lateral motion imparted to boot 134 as the stylus 112 is manipulated by a user. This motion is translated into a corresponding movement of indicia such as a cursor, game character, or the like displayed by display 108. It will be appreciated that other sensing technologies may also be used by detector 136 for sensing movement of stylus 112. For example, detector 136 may employ an optical or tactile sensor for sensing movement of boot 134 due to movement of the stylus 112 by the user.

In embodiments of the invention, detector 136 may also allow the user to select a point on the display 108 by applying a downward force on stylus 112. In this manner, the stylus 112 may be used, for example, to both move a cursor over an icon displayed by display 108 and then select or “click” on that icon without the use of a separate control button 114. The provision of such selection functions by joystick assemblies is described in U.S. Pat. No. 5,712,660, which is herein incorporated by reference in its entirety.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof It is the intention of the following claims to encompass and include such changes.

What is claimed is:

1. A joystick assembly for a palmtop information appliance having a housing including a display and a digitizer, comprising:
a stylus suitable for inputting information into the information appliance via the digitizer; and
a socket disposed in the housing for receiving an end of the stylus, the socket including a detector for detecting movement of the stylus received in the socket,
wherein the stylus is suitable for use as a joystick for controlling a function of the palmtop information appliance when the stylus is received in the socket.

2. The joystick assembly as claimed in claim 1, further comprising at least one control button disposed in the housing, the control button being suitable for use in conjunction with the stylus for controlling the function of the palmtop information appliance.

3. The joystick assembly as claimed in claim 1, wherein the detector comprises a force sensing apparatus for sensing lateral motion imparted to the stylus when the stylus is received in the socket.

4. The joystick assembly as claimed in claim 3, wherein the force sensing apparatus comprises a strain gauge.

5. The joystick assembly as claimed in claim 3, wherein the force sensing apparatus comprises a pressure sensitive resistive material.

6. The joystick assembly as claimed in claim 1, wherein the socket comprises a boot shaped for receiving the end of the stylus, the boot being suitable for preventing intrusion of environmental contaminants into the housing.

7. The joystick assembly as claimed in claim 1, wherein the function of the palmtop information appliance controlled by the joystick controller comprises a gaming function.

8. The joystick assembly as claimed in claim 1, wherein the function of the palmtop information appliance controlled by the joystick assembly comprises movement of a cursor.

9. A palmtop information appliance, comprising:
a housing including a display and a digitizer; and
a socket disposed in the housing for receiving an end of a stylus suitable for use in inputting information via the digitizer, the socket including a detector for detecting movement of the stylus received in the socket,
wherein the stylus is suitable for use as a joystick for controlling a function of the palmtop information appliance when the stylus is received in the socket.

10. The palmtop information appliance as claimed in claim 9, further comprising at least one control button disposed in the housing, the control button being suitable for use in conjunction with the stylus for controlling the function of the palmtop information appliance.

11. The palmtop information appliance as claimed in claim 9, wherein the detector comprises a force sensing apparatus for sensing lateral motion imparted to the stylus when the stylus is received in the socket.

12. The palmtop information appliance as claimed in claim 11, wherein the force sensing apparatus comprises a strain gauge.

13. The palmtop information appliance as claimed in claim 11, wherein the force sensing apparatus comprises a pressure sensitive resistive material.

14. The palmtop information appliance as claimed in claim 9, wherein the socket comprises a boot shaped for receiving the end of the stylus, the boot being suitable for preventing intrusion of environmental contaminants into the housing.

15. The palmtop information appliance as claimed in claim 9, wherein the function of the palmtop information appliance controlled by the joystick controller comprises a gaming function.

16. The palmtop information appliance as claimed in claim 9, wherein the function of the palmtop information appliance controlled by the joystick assembly comprises movement of a cursor.

17. The palmtop information appliance as claimed in claim 9, further comprising a holder formed in the housing for retaining the stylus when the stylus is not being used.

18. A palmtop information appliance, comprising:
a housing including a display and a digitizer;
a stylus suitable for inputting information via the digitizer; and
a socket disposed in the housing for receiving an end of the stylus, the socket including a detector for detecting movement of the stylus received in the socket,
wherein the stylus is suitable for use as a joystick for controlling a function of the palmtop information appliance when the stylus is received in the socket.

19. The palmtop information appliance as claimed in claim 18, further comprising at least one control button disposed in the housing, the control button being suitable for use in conjunction with the stylus for controlling the function of the palmtop information appliance.

20. The palntop information appliance as claimed in claim 18, wherein the detector comprises a force sensing apparatus for sensing lateral motion imparted to the stylus when the stylus is received in the socket.

21. The palmtop information appliance as claimed in claim 20, wherein the force sensing apparatus comprises a strain gauge.

22. The palmtop information appliance as claimed in claim 20, wherein the force sensing apparatus comprises a pressure sensitive resistive material.

23. The palmtop information appliance as claimed in claim 18, wherein the socket comprises a boot shaped for receiving the end of the stylus, the boot being suitable for preventing intrusion of environmental contaminants into the housing.

24. The palmtop information appliance as claimed in claim 18, wherein the function of the palmtop information appliance controlled by the joystick controller comprises a gaming function.

25. The palmtop information appliance as claimed in claim 18, wherein the function of the palmtop information appliance controlled by the joystick assembly comprises movement of a cursor.

26. The palmtop information appliance as claimed in claim 18, further comprising a holder formed in the housing for retaining the stylus when the stylus is not being used.

27. A palmtop information appliance, comprising:
means for housing a display and a digitizer; and
means, disposed in the housing means, for receiving an end of a stylus suitable for use in inputting information via the digitizer, the receiving means including means for detecting movement of the stylus received in the receiving means,
wherein the stylus is suitable for use as a joystick for controlling a function of the palmtop information appliance when the stylus is received in the receiving means.

28. The palmtop information appliance as claimed in claim 27, further comprising at least one control button disposed in the housing means, the control button being suitable for use in conjunction with the stylus for controlling the fiction of the palmtop information appliance.

29. The palmtop information appliance as claimed in claim 27, wherein the function of the palmtop information appliance controlled by the joystick comprises a gaming function.

30. The palmtop information appliance as claimed in claim 27, wherein the function of the palmtop information appliance controlled by the joystick comprises movement of a cursor.

31. The palmtop information appliance as claimed in claim 27, further comprising means, formed in the housing means, for retaining the stylus when the stylus is not being used.
